(19) United States
(12) Patent Application Publication
(10) Pub. No.: US 2011/0303156 A1
(43) Pub. Date: Dec. 15, 2011

(54) LONG LASTING, NON-WETTING, ODOR FREE, EASILY MANAGEABLE ANIMAL LITTER AND LITTER BOX USABLE THEREWITH

(75) Inventors: Vinod K. Sikka, Oak Ridge, TN (US); Andrew K. Jones, Lancaster, PA (US); Jay Paul Otto, Lititz, PA (US); Russell Ross, Leola, PA (US)

(73) Assignee: ROSS TECHNOLOGY CORPORATION, Leola, PA (US)

(21) Appl. No.: 13/108,755

(22) Filed: May 16, 2011

Related U.S. Application Data
(63) Continuation of application No. PCT/US2009/064640, filed on Nov. 16, 2009.
Application No. PCT/US2009/064640 is a continuation-in-part of application No. PCT/US2009/005512, filed on Oct. 7, 2009.
(60) Provisional application No. 61/114,744, filed on Nov. 14, 2008.

(51) Int. Cl. A01K 29/00; A01K 1/015

(52) U.S. Cl. 119/165; 119/173

(57) ABSTRACT

Described herein is a hydrophobic, nonabsorbent animal litter suitable fore use with cats and other animals. Also described are methods of preparing the litter, and a litter box for use with hydrophobic, nonabsorbent animal litter.

This application claims the benefit of U.S. Provisional Application 61/114,744, filed Nov. 14, 2008; this application is a continuation in part of PCT/US09/57183 entitled “Highly Durable Superhydrophobic, Oleophobic And Anti-Icing Coatings And Methods and Compositions For Their Preparation” filed Oct. 7, 2009, both of which are incorporated by reference in their entirety.

### BACKGROUND

The present disclosure relates to the field of litter for household pet waste systems, and more particularly to an improved animal litter composition and apparatus for using the improved litter composition that is pet friendly, easy to clean, long lasting, reduces odors, offers easily disposable, is free from adverse health effects, and which requires lower energy use for the manufacture of litter composition.

Clumping litters are the most common types litter used today. Clumping type litter was first developed in the UK in the 1950s by the Fuller's Earth Union (FEU), later to become a part of Laporte Industries Ltd. The type of clumping litter developed by the FEU was calcium bentonite, which swells less and is less sticky than American bentonite. Subsequently, clumping bentonite was developed in 1984 in the United States by biochemist Thomas Nelson. Most clumping litters are made from granulated bentonite clay which clumps together when wet and form a solid mass separate from the other litter in the box, and limiting contamination of the remaining, non-wetted litter in the box. The clumped material can then be removed from the box and disposed of without requiring that the entire contents of the litter box be changed as frequently as with non-clumping litters. However, the entire contents should be changed on a regular basis to prevent buildup of bacteria; every four to six weeks is recommended. Approximately 69% of the cat litter market consists of clumping litter. In recent years, there are increasing claims that clumping litter can be harmful to pets because if it is inhaled or ingested it swells and solidifies internally. This is thought to be particularly dangerous for kittens, who are more likely to ingest cat litter and less likely to recover easily. However, other than anecdotal testimonials, there has been little evidence for the claim and no confirmed cases in the scientific literature. Clumping clay cat litters also contain crystalline silica, or silica dust, which is a known carcinogen. It has been proven to not be a significant risk to humans, but there are no studies showing the effects of silica dust on cats. Clay litter has also come under scrutiny due to the fact that the clay used in its production is commonly strip-mined in an environmentally undesirable process.

Feline experts say cats are most comfortable with fine-grained, clumping clay cat litter. Clay cat litter can't be flushed down the toilet. Some pet owners are concerned about the clumping chemical it contains. Most fine-grained clumping clay litter is not meant for kittens younger than three months, who could accidentally ingest some of the particles. Also, cats tend to track fine-grained clay litters around the house after exiting a litter box, such that use of such litters requires more vacuuming than with other types of kitty litter.

### Alternative for Kittens or Special-Needs Cats

Dr. Elsey's Precious Cat Attract Cat Litter—This product is a favorite among veterinarians and cat experts, who say the herb-scented, clumping clay Cat Attract, is a good choice for training kittens to use the litter box, as well as for reinforcing this habit with grown cats that may tend to urinate outside the litter box.

Silica Gel Litter—Silica gel litter, a porous granular form of sodium silicate also called crystal cat litter, has the highest absorbency of any litter, and provides excellent moisture and odor control. Crystal litter is extremely lightweight, especially when compared to heavier clay and clumping litter. Silica gel litter comes in two shapes: irregular lumps and small beads. Particle size ranges from 0.5 mm to 4 mm. Crystal litter, however, gives no warning when it is saturated; the next cat to use the litter box will leave a urine puddle at the bottom of the litter box. When crystal litter becomes saturated it also begins to smell. Moreover, in contrast to the 4-5 pounds of silica litter needed for a normal cat over 30 days, it may take 20-30 lbs (9-14 kg) or more of clumping clay litter for pet waste management over the same time period because one has to replenish the litter that is removed when the clumped urine is scooped out.

### Alternatives to Clay Cat Litter

Numerous natural alternatives to clumping clay kitty litters, such as plant-based litters, are available at pet, health food and feed stores. Plant-based litters are usually made from some combination of wheat, alfalfa, oat hulls, corn cob, peanut hulls, or recycled newspaper.

Clumping, scoopable litters include: SWheatScoop (on the world wide web at: swheatscoop.com); Wonder Wheat (on the world wide web at: wonderwheat.com.au) the Australian equivalent of SWheatScoop; The World's Best Cat Litter (on the world wide web at: worldsbestcatlitter.com); Nature's Miracle® Clumping Cat Litter (on the world wide web at: naturemakesitwork.com/catalog/catalog.php?cat=Cat), which is corn based. Non-clumping litters include: Care Fresh® (on the world wide web at: absorbent.com/animal.html); Feline Pine (on the world wide web at: felinepine.com); FIELDFresh® (on the world wide web at: andersonsinc.com/processing/FF.html), which is a corn cob based litter; Good Mews® (on the world wide web at: stutzman-environmental.com/goodmews.htm), which is recycled paper (or cellulose fiber) making it 100% biodegradable; PaPurr® (on the world wide web at: grantekinc.com/papurr_main.html), also made from recycled paper; Yesterday's News® (on the world wide web at: yesterdaysnews.com); Cat Country® (on the world wide web at: mtnmeadowspet.com). Plant-based, dust-free, biodegradable and flushable; Dr. Kenaf's Amazing Cat Litter (on the world wide web at: kenaf corn), which is made from the Kenaf plant; and Luv My Kitty® (on the world wide web at: luvlitters.com/kitty.htm), which is a wood based litter. Other alternatives include: Pinnacle Pine Cat Litter (on the world wide web at: pinnaclepellet.com) pine shavings compressed into wood pellets; Nature's Logic Ponderosa Pine Cat Litter (www.natureslogic.com/products/cp_litter.html) made from ponderosa pine; and Vetbasis® Nature Derived Herbal Cat Litter (on the world wide web at: vetbasis.com/cats.asp).

A litter comparison chart of cat litters is shown in Table 1

TABLE 1
Comparison of Cat Litter Used for House Cats

| | | | Con- | Litter | | | | | Cost | | |
|---|---|---|---|---|---|---|---|---|---|---|---|
| Type | Natural | | trols | Box | Con- | Less | Change | | Unit | Week | |
| Of | Odor | Health | Mois- | Condi- | trols | Track- | Inter- | | ($/ | ($/ | |
| Litter | Control | Hazard | ture | tion | Dust | ing | val | | lb) | week) | Comments |
| Tradi- | No | Yes | No | Wet | No | No | 1-3 | days | .15 | 1.75 | May have chemicals to suppress the odor |
| tional | | | | | | | | | | | |
| Clay | | | | | | | | | | | |
| Clumping | No | Yes | No | Dry | No | No | 1-2 | weeks | .40 | 2.00 | Chemicals and dust buildup in animals' lungs |
| Clay | | | | | | | | | | | |
| Paper | No | No | No | Wet | No | Some | 1-3 | days | .60 | 2.00 | Moisture allows smell and bacteria growth |
| Corn Cob | No | No | No | Wet | Some | Some | 3-7 | days | .60 | 2.80 | |
| Citrus | Some | No | No | Wet | No | No | 1-3 | days | .40 | 2.00 | |
| Wheat | No | Some | No | Wet | No | No | 1-3 | days | | | Limited availability diminishes significance |
| Grass | No | No | No | Wet | Some | No | 1-3 | days | | | Limited availability diminishes significance |
| Silica | No | Yes | No | Wet | No | No | 1-3 | days | | | Limited availability diminishes significance |
| Peanut | No | No | No | Wet | Some | Some | 1-3 | days | .40 | 2.00 | |
| Pine | Some | No | Some | Some | Yes | Yes | 0-1 | week | .60 | 2.80 | |
| Pellets | | | | | | | | | | | |
| Breeze | Yes | No | Yes | Dry | Yes | Yes | Varies | | | | Manufacturer recommends one system per cat |
| | | | | | | | | | | | plus one extra system |
| | | | | | | | | | | | Pads need to be changed after one week for |
| | | | | | | | | | | | one cat, three days for two cats. etc. |
| | | | | | | | | | | | Manufacturer states that pellets will last |
| | | | | | | | | | | | one month |
| Luv My | Yes | No | Yes | Dry | Yes | Yes | 2-4 | weeks | .60 | .70 | Naturally eliminates odors |
| Kitty | | | | | | | | | | | No dust, no chemicals, no internal buildup, |
| | | | | | | | | | | | no urinary disease |
| | | | | | | | | | | | The crumbles are so porous, the moisture |
| | | | | | | | | | | | evaporates along with odor |
| Non- | Yes | No | Yes | Dry | Yes | Yes | 6-8 | weeks | TBD** | TBD** | Litter says dry |
| wetting | | | | | | | | | | | Uses minimum amount of litter |
| Litter* | | | | | | | | | | | Replace litter in 6 to 8 weeks |
| | | | | | | | | | | | Urine is pumped out into reusable container |
| | | | | | | | | | | | No odor |

*This invention.
**TBD—to be determined.

Concerns with Traditional Cat Litters

Clumping clay kitty litters may be related to a wide variety of seemingly unrelated cat health problems, included diarrhea, frothy yellow vomiting, mega-bowel syndrome, irritable bowel syndrome, kidney problems, respiratory problems, general failure to thrive, anemia, lethargy, and even death.

Although regular clay litters do not pose the potential health hazards that clumping clay kitty litters do, they do have their own problems. Mining clay is hard on the environment and clay litters contribute significantly to landfills. Each year, over 2 million tons of cat litter, or approximately 100,000 truckloads, ends up in landfills in the U.S. alone. In addition, most, if not all, clay litters contain silica, which is potentially harmful. Crystalline silica, once airborne, can cause silicosis, characterized by incurable lesions on the lungs and throat, rendering that tissue useless for transferring oxygen. Crystalline silica is a naturally occurring element, also known as quartz, and is found in some of the clay litters. The problems extend beyond cats. Dogs get that into the litter box for “snacks,” ingest the litter, and an autopsy of at least one dog revealed that his stomach was filled with the clumping litter.

### SUMMARY

Described herein are animal litter compositions comprising a non-absorbent granular material having a contact angle with water greater than about 90 degrees suitable fore use with cats and other animals. Also described are methods of preparing such animal litter, and a litter box for use with hydrophobic, nonabsorbent animal litter.

### BRIEF DESCRIPTION OF THE DRAWINGS

FIG. 1 shows a litter box for use with non-absorbent litter.

FIG. 2 shows the same litter box with an enclosure over the top.

FIG. 3 shows several views of a litter box as shown in FIG. 1 with potential sizes for use with cats.

FIG. 4 shows one several views of an example of a pump (sump column) for use with the litter boxes such as those described in FIGS. 1-4 or with other litter boxes. In one embodiment, the pump comes with an adhesive material on the base of the pump that can be used to attach the pump to a litter box.

### DETAILED DESCRIPTION

### 1.0 Definitions

Hydrophobic as applied to surfaces of a litter box is, defined as a surface having a contact angle with water greater than 150 degrees, and thus includes superhydrophobic and ultrahydrophobic unless stated otherwise.

Non-absorbent (non-absorbing) as used herein for animal litter means the litter does not absorb substantial amounts of aqueous solutions such as urine. The volume of aqueous solution absorbed is based on the application of 200 ml of water or urine to 200 grams of litter after which the aqueous material is drained away. Depending upon the shape and type of the litter employed it may be necessary to remove trapped droplets from the litter to distinguish retained from absorbed aqueous materials. Trapped droplets can be removed by a variety of techniques including centrifugation with modest force (e.g., 2 to 20×g).

Non-wetting (non-wettable) as used herein means the material is both non-absorbent and has a contact angle with water greater than about 90 degrees. In some embodiments the material is non-absorbent and has a contact angle with water greater than a contact angle selected from: 100, 110, 120, 130, 140, 150, 160, or 170 degrees measured at about 18 to 24° C.

Granular as used here in means individual pieces of regular or irregular shape.

Coarse diatomaceous earth (DE) particulates are of 100 microns to 2000 microns.

### 2.0 Animal Litter Compositions

2.1 Litter Materials

One aspect of the present disclosure is an animal litter composition comprising a non-absorbent granular material having a contact angle with water greater than about 90 degrees (referred to hereinafter as “non-absorbent granular litter”). In one embodiment, non-absorbent granular litter absorbs less than 8% of the volume of water that is applied to litter is absorbed. In other embodiments, less than 6%, 5%, 4%, 3%, 2%, or 1% of the aqueous solution applied to animal litter is absorbed. In some embodiments the non-absorbent granular litter has a contact angle with water greater than a contact angle selected from: 100, 110. 120, 130, 140, 150, 160, or 170 degrees measured at about 18 to 24° C.

Such litter can be prepared from clumping or non-clumping materials by suitable treatments. For example, a clumping clay animal litter that is water/urine absorbent can be treated with a solution comprising 1% of a silane (silanizing agent) that soaks into the litter but does cause the litter to clump. The silane soaked clumping litter when heated to about 93° C. (200° F.) for 20-30 minutes covalently binds the silane to the clay resulting in a clay litter that typically appears the same as the untreated litter, but is substantially or totally water and urine repellant.

Non-absorbent granular litter can be prepared from a variety of materials including, but not limited to, plant materials, clay, silica, glass, ceramic, fly ash, slag (ground or reduced in size as desired), gypsum, water glass based materials, chalk based materials, coarse DE particulates, cardboard, cardboard coated with water glass, gravel, vermiculite, perlite, investment slurry coated paper, and card board, extruded rubber, ground rubber, and/or plastic.

Where the material to be used as non-absorbent granular litter is smaller than suitable for litter particles, or where combinations of materials are to be employed, the materials may be combined and formed into granules of the desired size using a variety of techniques, including but not limited to compression, heating (e.g., for silica gels or clays), extrusion, mixing with one or more binders, or combinations thereof. Suitable binders include, but are not limited to, polyurethanes, epoxies, clays, waxes, glues, water glass, cement, plaster, and the like.

Where materials to be used for non-absorbent granular litter are too large, they may be reduced in size by any suitable means including crush, cutting and the like.

In some embodiments non-absorbent granular litter is prepared from one or more suitable plant materials including, but not limited to, one or more of parts of wheat, alfalfa, oat, corn, or peanut plants, or trees (e.g., wood or wood pulp materials, such as cardboard or newspaper that has been shredded or formed into pellets or particles). In one embodiment, the litter composition can comprise granules or particles of one or more of wheat hulls, alfalfa hulls, oat hulls, corn cobs, peanut shells, saw dust, pelleted sawdust, wood shavings, and pelleted wood shavings or saw dust (e.g., particles of compressed sawdust with or without a binder).

A variety of clays can be used to prepare the non-absorbent granular litter described herein. Typically, the clays will be a clumping clay litter, such as form of bentonite, or a non-clumping clay litter incorporating kaolin. It is also possible to use a combination of clumping and non-clumping clays.

Clumping litter also usually contains quartz or diatomaceous earth (sometimes called diatomaceous silica, which causes it to be mistakenly confused with silica gel litter). Because of the clumping effect, it is not recommended to flush clumping litters down the toilet.

In one embodiment, litter comprising a clumping clay containing bentonite (Al₂O₃.4(SiO₂).H₂O), can be converted into non-absorbent granular litter by treatment with a silanizing agent. In one embodiment, the clumping clay litter is treated with a non-fluorinated silane as exemplified in the first reaction shown in Scheme I. In another embodiment, the clumping clay litter is treated with a fluorinated silane, as exemplified in the second reaction given in Scheme I.

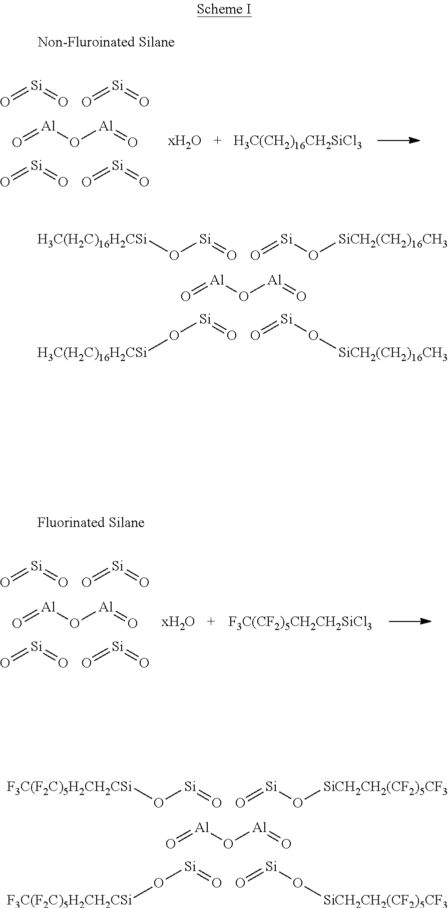

Silica, silicates, glasses, or ceramic materials (e.g., fired clays) may also be employed prepare non-absorbent granular litter, and can be used in combination with other litter components, particularly clays.

Silica is a porous granular form of sodium silicate that has the formula Na₂SiO₃. Sodium silicate is a white solid that is readily soluble in water, producing an alkaline solution. It is one of a number of related compounds which include sodium orthosilicate, Na₄SiO₄; sodium pyrosilicate, Na₆Si₂O₇, and others. All dissolve in water and most are glassy and colorless. In its anhydrous form sodium silicate contains a chain polymeric anion composed of corner shared {SiO₄} tetrahedra, and not a discrete SiO₃²⁻ ion. In addition to the anhydrous form, there are a number of hydrates with the formulae Na₂SiO₃.nH₂O (where n=5, 6, 8, 9), which contain the discrete, approximately tetrahedral anion SiO₂(OH)₂²⁻ with water of hydration (e.g., commercially available sodium silicate pentahydrate (CAS #10213-79-3), Na₂SiO₃.5H₂O is formulated Na₂SiO₂(OH)₂.4H₂O and the nonahydrate, Na₂SiO₃.9H₂O (CAS #13517-24-3) is formulated Na₂SiO₂(OH)₂.8H₂O.

Sodium silicate is stable in neutral and alkaline solutions. In acidic solutions, the silicate ion reacts with hydrogen ions to form silicic acid, which when heated forms silica gel, a hard, glassy substance. Sodium silicates are inherently intumescent. They come in prill (solid bead) form, as well as the liquid, water glass, which is discussed further below.

Silica powders that may be employed to prepare non-absorbent granular litter include, but are not limited to, CAB-O-SIL® and NANOGEL® (Cabot Corp., MA), and Zeoflo® TL Silica Hydrophobic Silicon Dioxide (J.M. Huber Corporation, Atlanta, Ga.). Some specific treated silicas and silica gels that can be used to produce non-wetting litter are given in the table below.

| | | | NOMINAL |
|---|---|---|---|
| | | | BET |
| | | | SURFACE |
| | | | AREA OF |
| CAB-O-SIL | SURFACE | LEVEL OF | BASE |
| GRADE | TREATMENT | TREATMENT | SILICA (m²/g) |
| M-5 | None | None | 200 |
| TS-610 | Dimethyldichlorosilane | Intermediate | 130 |
| TS-530 | Hexamethyldisilazane | High | 320 |
| TS-382 | Octyltrimethyoxysilane | High | 200 |
| TS-720 | Polydimethylsilioxane | High | 200 |

In some embodiments, silica powders that are to be formed into larger granule are employed to prepare non-absorbent granular litter. Where silica or silica gels or powders are to be formed into granules of a larger size, any method known in the art may be employed, including:
1. Pressing powder into compacts in a die operation. The compacts are held together by mechanical bonding caused by pressure.
2. Pressing powder into compacts in a die operation, where a small amount of a binder is added to the powders and gels. The binders can be epoxies, polyurethanes, or others.
3. Press and sinter is another approach. In this case, a die and press operation will be used to press pellets, which will be sintered.
   For pre-silane treated powders (e.g., silicas/silica gels treated with a silanizing agent) sintering should be conducted at temperatures <500° C. Above that temperature, the covalent bonds between the silane and the silicas are not stable. For the pellets of untreated silicas, the sintering temperature can be as high as 1000° C. The sintered pellets will need to be silane-treated after the sintering process, in which case any of the silanizing agents recited herein can be employed.

In one embodiment, the silica or silica containing litter is treated with a non-fluorinated silane (silanizing agent) to prepare non-absorbent granular litter as exemplified in the first reaction shown in Scheme II In another embodiment, the silica or silica containing litter is treated with a fluorinated silane (silanizing agent) to prepare non-absorbent granular litter as exemplified in the second reaction given in Scheme II.

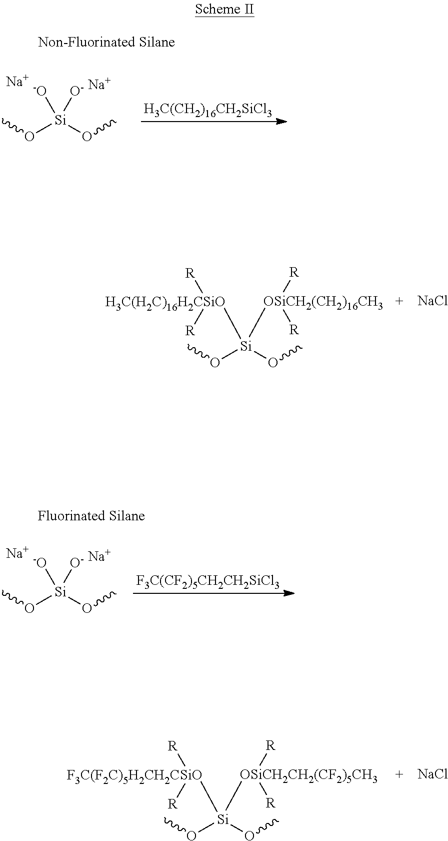

In another embodiment, non-absorbent granular litter is prepared from fly ash generated in the combustion of coal. Fly ash is generally captured from the chimneys of coal-fired power plants, whereas bottom ash is removed from the bottom of the furnace. As fly ash solidifies while suspended in the exhaust gases the particles are generally spherical in shape and range in size from 0.5 μm to 100 μm. Fly ash is typically collected by electrostatic precipitators or filter bags.

Fly ash is generally highly heterogeneous, consisting of a mixture of glassy particles with various identifiable crystalline phases such as quartz, mullite, and various iron oxides. Depending upon the source and makeup of the coal being burned, the components of the fly ash produced vary considerably, but all fly ash includes substantial amounts of silicon dioxide (SiO2) (both amorphous and crystalline) and calcium oxide (CaO). The silicon dioxide (SiO₂) is typically present in two forms; amorphous, which is rounded and smooth, and crystalline, which is sharp, pointed and hazardous. The ash may can contain various amounts of aluminum oxide (Al₂O₃) and/or iron oxide (Fe₂O₃).

Two classes of fly ash are defined by ASTM (American Society for Testing and Materials) C618: Class F fly ash and Class C fly ash. The chief difference between these classes is the amount of calcium, silica, alumina, and iron content in the ash. The chemical properties of the fly ash are largely influenced by the chemical content of the coal burned (i.e., anthracite, bituminous, and lignite).

| Component | Bituminous | Subbituminous | Lignite |
|---|---|---|---|
| SiO₂ (%) | 20-60 | 40-60 | 15-45 |
| Al₂O₃ (%) | 5-35 | 20-30 | 20-25 |
| Fe₂O₃ (%) | 10-40 | 4-10 | 4-15 |
| CaO (%) | 1-12 | 5-30 | 15-40 |
| LOI (%) | 0-15 | 0-3 | 0-5 |

Not all fly ashes meet ASTM C618 requirements, although depending on the application, this may not be necessary. Ash used as a cement replacement must meet strict construction standards, but no standard environmental standards have been established in the United States. 75% of the ash must have a fineness of 45 μm or less, and have a carbon content, measured by the loss on ignition (LOI), of less than 4%. In the U.S., LOI needs to be under 6%. The particle size distribution of raw fly ash fluctuates due to changing performance of the coal mills and the boiler performance.

The burning of harder, older anthracite and bituminous coal typically produces Class F fly ash, which is pozzolanic in nature, and usually contains less than 10% lime (CaO). Although pozzolanic, the glassy silica and alumina of Class F fly ash requires a cementing agent, such as Portland cement, quicklime, or hydrated lime (slaked lime). When present in the presence of sufficient water cementitious compositions are produced. Alternatively, the addition of a chemical activator such as sodium silicate (water glass) to a Class F ash can lead to the formation of a geopolymer.

Class C fly ash produced from the burning of younger lignite or subbituminous coal, in addition to having pozzolanic properties, also has some self-cementing properties. In the presence of water, Class C fly ash will harden and gain strength over time. Class C fly ash generally contains more than 20% lime (CaO). Alkali and sulfate (SO4) contents are generally higher in Class C ash than in Class F ash. Unlike Class F ash, self-cementing Class C fly ash does not require an activator.

The use of fly ash in animal litter offers an alternative both to its disposal in landfills and to the use of virgin materials for the creation of animal litter. Moreover, its pozzolanic properties and relatively uniform size permit it preparation into granular materials suitable for use as animal litter.

Non-absorbent granular litter may be prepared from gypsum, which is a natural mineral that can be mined or obtained from other sources. The semi-hydrous form of calcium sulfate (CaSO4.½H₂O) is used as plaster. Raw gypsum (mined or obtained by flue gas desulfurization) must be calcined before use. For preparing animal litter, plaster prepared from gypsum may be mixed with fillers including, but not limited to, fly ash, slag, silica/silicates, sand, fiber glass, and the like.

Slag from the refining of metals, like fly ash, may also be employed in the preparation of non-absorbent granular litter. The slag may be from the preparation of ferrous or non-ferrous metals, and it may be combined with other materials, including silica/silicates and/or fly ash to prepare non-absorbent granular litter.

In one embodiment, non-absorbent granular litter comprises one or more of fly ash, slag, silica, a silicate, and gypsum. Such non-absorbent granular litter may be prepared in granular form by combination with water and a cementing material as needed (e.g., portland cement, CaO or Ca(OH)₂).

In another embodiment the non-absorbent granular litter comprises type F fly ash, type C fly ash, slag from ferrous metal refining, or slag from non-ferrous metal refining.

Non-absorbent granular litter may be prepared employing water glass, which is the common name for sodium metasilicate, Na₂SiO₃, and which is also known liquid glass. Water glass or soluble glass, is a colorless, transparent, glasslike substance commercially available as a powder or as a transparent, viscous solution in water. Chemically it is sodium silicate, potassium silicate, or a mixture of these. It is available in aqueous solution (CAS #1344-09-08) and in solid form, and may be prepared by reacting sodium or potassium carbonate and silicon dioxide in molten form, releasing carbon dioxide in the process: Na₂CO₃+SiO₂→Na₂SiO₃+CO₂, which is shown of sodium carbonate. Water glass is very soluble in water, but the glassy solid dissolves slowly, even in boiling water. Water glass has adhesive properties and is fire resistant. It is used as a detergent; as cement for glass, pottery, and stoneware; for fireproofing paper, wood, cement, and other substances; for fixing pigments in paintings and cloth printing; and for preserving eggs (it fills the pores in the eggshell, preventing entrance of air).

Water glass is a useful binder of solids, and may be used to prepare water glass based materials for use as animal litter. The materials that can be bound include, but are not limited to paper, saw dust, and wood shavings, which may be formed into suitable size granules or pellets by compressing the materials wet with a solution of water glass. Water glass may also be used as a binder for vermiculite and perlite.

In one embodiment, non-absorbent granular litter includes, but is not limited to, compositions comprising materials aggregated or bound together with water glass. In another embodiment, the materials include one or more of fly ash, paper, cardboard saw dust, wood shavings gravel, vermiculite or perlite, alone or in combination. In such an embodiment the litter can be shaped into suitable sized granules or particles by any of a variety of means including extruding, pelleting, crushing or chopping/cutting.

Non-absorbent granular litter may be formed from plastics. Suitable plastics include, but are not limited to, polyolefins, polyvinylchloride, a polyamides, a polyimides, a polyamideimides, a polyesters, aromatic polyesters, polycarbonates, polystyrenes, polysulfides, polysulfones, polyethersulfones, polyphenylenesulfides, a phenolic resins, polyurethanes, epoxy resins, a silicon resins, acrylonitrile butadiene styrene resin/plastic, methacrylic resins/plastics, acrylate resins, polyacetals, polyphenylene oxides, polymethylpentenes, melamines, alkyd resins, polyesters or unsaturated polyesters, polybutylene terephthlates and/or nylon.

In some embodiments, non-absorbent granular litter is not made from plastic or does not comprise a plastic.

2.2 Introducing Hydrophobicity and Nonabsorbent Properties into Litter Materials

Water repellant (e.g., hydrophobicity) and non-absorbent properties can be introduced into animal litter by treatment with a variety of chemical agents that introduce hydrophobic groups, including but not limited to silane groups (moieties). In some embodiments, non-absorbent granular litter may have a contact angle with water that is greater than a contact angle selected from about: 100, 110, 120, 130, 140, 150, 160, or 170 degrees measured at about 18 to 24° C.

In one embodiment, compositions of non-absorbent granular litter comprising the materials described in section 2.1, supra, comprise silane moieties that are introduced by treating the materials with a silanizing agent.

In one embodiment, a silanizing agent used to prepare non-absorbent granular litter is a silanizing agent of formula (I):

R₄₋ₙSi—Xₙ (I)

where n is an integer from 1 to 3;
each R is independently selected from
   (i) alkyl or cycloalkyl group optionally substituted one or more fluorine atoms,
   (ii) C₁₋₂₀ alkyl optionally substituted with one or more independently selected substituents selected from fluorine atoms and C₆₋₁₄ aryl groups, which aryl groups are optionally substituted with one or more independently selected halo, C₁₋₁₀ alkyl, C₁₋₁₀ haloalkyl, C₁₋₁₀ alkoxy, or C₁₋₁₀ haloalkoxy substituents,
   (iii) C_{6 to 20} alkyl ether optionally substituted with one or more substituents independently selected from fluorine and C₆₋₁₄ aryl groups, which aryl groups are optionally substituted with one or more independently selected halo, C₁₋₁₀ alkyl, C₁₋₁₀ haloalkyl, C₁₋₁₀ alkoxy, or C₁₋₁₀ haloalkoxy substituents,
   (iv) C₆₋₁₄ aryl, optionally substituted with one or more substituents independently selected from halo or alkoxy, and haloalkoxy substituents;
   (v) C_{6 to 20} alkenyl or C_{6 to 20} alkynyl, optionally substituted with one or more substituents independently selected from halo, alkoxy, or haloalkoxy; or
   (vi) —Z—((CF₂)_{q}(CF₃))ᵣ, wherein Z is a C₁₋₁₂ divalent alkane radical or a C₂₋₁₂ divalent alkene or alkyne radical, q is an integer from 1 to 12, and r is an integer from 1-4;
each X is independently selected from —H, —Cl, —I, —Br, —OH, —OR², —NHR³, or —N(R³)₂;
each R² is independently selected C₁₋₄ alkyl or haloaklyl group; and
each R³ is independently an independently selected H, C₁₋₄ alkyl or haloalkyl group.

In one embodiment, of compounds of formula 1, R is selected from: (a) an alkyl or fluoroalkyl group having from 6 to 20 carbon atoms; (b) an alkyl or fluoroalkyl group having from 8 to 20 carbon atoms; (c) an alkyl or fluoroalkyl group having from 10 to 20 carbon atoms; (d) an alkyl or fluoroalkyl group having from 6 to 20 carbon atoms when n is 3; (e) an alkyl or fluoroalkyl group having from 8 to 20 carbon atoms when n is 3; and (f) an alkyl or fluoroalkyl group having from 10 to 20 carbon atoms when n is 3.

In one embodiment, of compounds of formula I, R is —Z—((CF₂)_{q}(CF₃))ᵣ, where Z is a C₁₋₁₂ divalent alkane radical or a C₂₋₁₂ divalent alkene or alkyne radical, and q is an integer from 1 to 12, and r is an integer from 1-4.

In other embodiments of compounds of formula I, n is 3, or 2 or 1.

In one embodiment, of compounds of formula I, all halogen atoms present in any one or more R groups are fluorine atoms.

In one embodiment, each X group of compounds of formula I is selected independently from H, Cl, —OR², —NHR³, and —N(R³)₂. Alternatively, in another embodiment, each X is independently selected from Cl, —OR2, —NHR³, and —N(R³)₂. In still another embodiment each X is independently selected from, Cl, —NHR³, and —N(R³)₂.

Non-absorbent granular litter may be prepared using more than one compound of formula I. In some embodiment the material used for non-absorbent granular litter is treated with two or more, three or more, or four or more compounds of formula (I), employed alone or in combination.

In one embodiment, the materials used to prepare non-absorbent granular litter are treated with a silanizing agent selected from tridecafluoro-1,1,2,2-tetrahydrooctyl)silane (SIT8173.0); (tridecafluoro-1,1,2,2-tetrahydrooctyl)trichlorosilane (SIT8174.0); (tridecafluoro-1,1,2,2-tetrahydrooctyl)triethoxysilane (SIT8175.0); (tridecafluoro-1,1,2,2-tetrahydrooctyl)trimethoxysilane (SIT8176.0); (heptadecafluoro-1,1,2,2-tetrahydrodecyl)dimethyl(dimethylamino)silane (SIH5840.5); (heptadecafluoro-1,1,2,2-tetrahydrodecyl)tris(dimethylamino)silane (SIH5841.7); n-octadecyltrimethoxysilane (SIO6645.0); n-octyltriethoxysilane (SIO6715.0); and nonafluorohexyldimethyl(dimethylamino)silane (SIN6597.4). The number provided in parentheses is the reference number of the supplier (Gelest, Morrisville, Pa.).

Other sources of silanizing agents that can be use to prepare non-absorbent granular litter include, but are not limited to: Momentive Performance Materials, Albany, N.Y.; which produces, for example gamma-aminopropyltriethoxysilane; Evonik Industries AG, Essen, Germany which produces, tetraethylorthosilicate and hexamethyldisilazane.

Some reaction mechanisms for exemplary silanizing agents with hydroxyl containing materials that can be used to prepare animal litter are provided in Schemes III to IX as provided below.

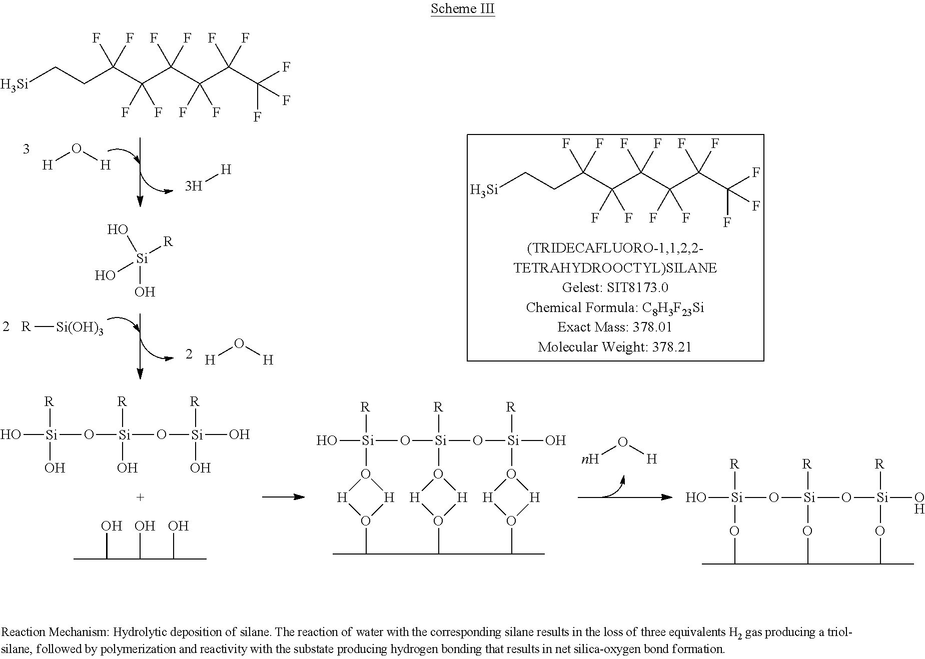

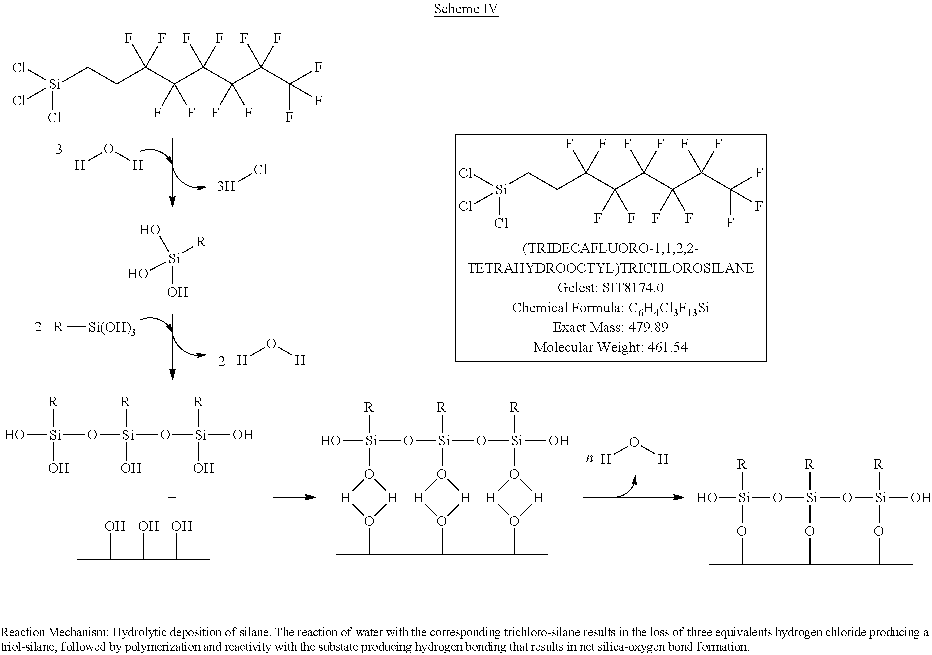

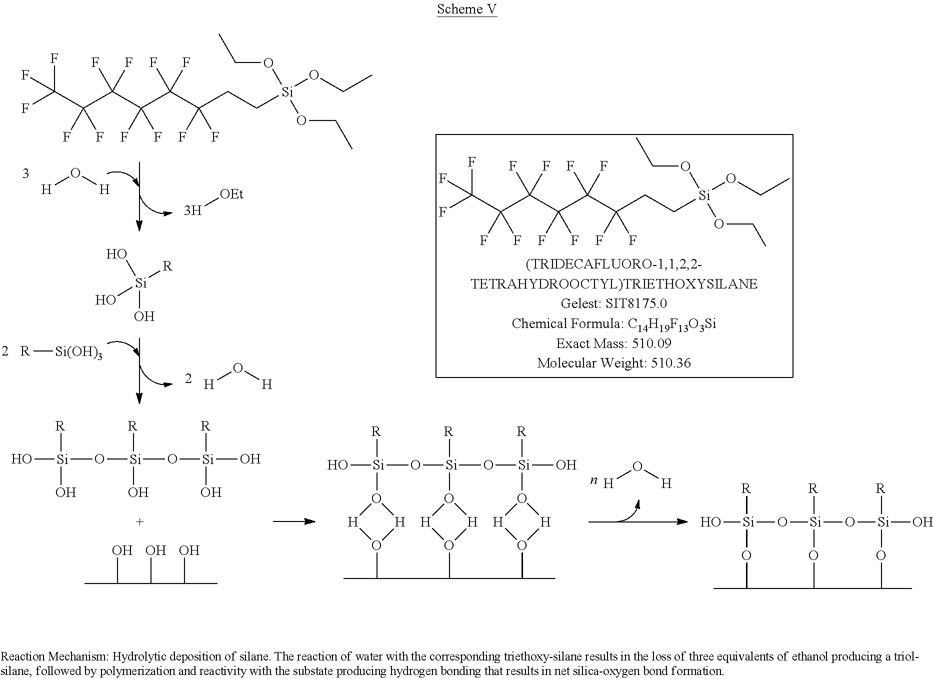

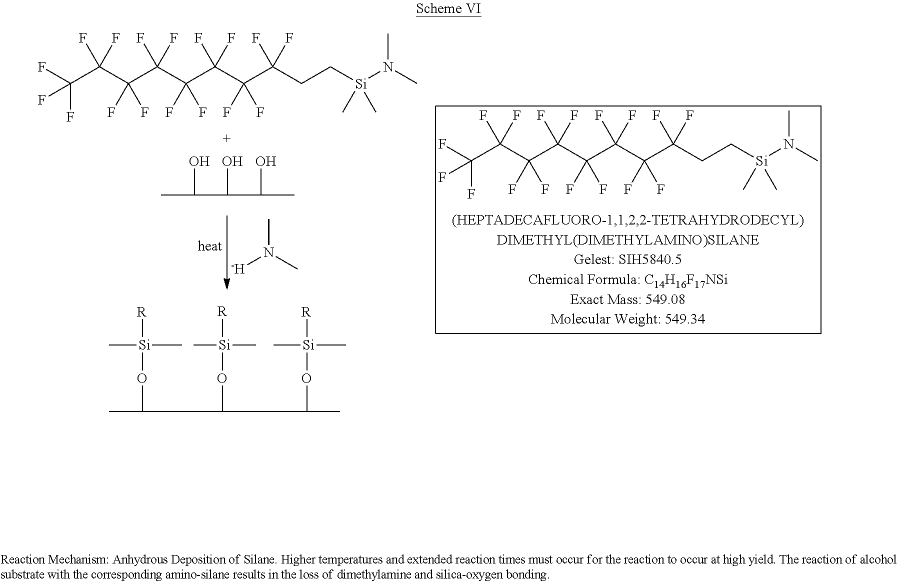

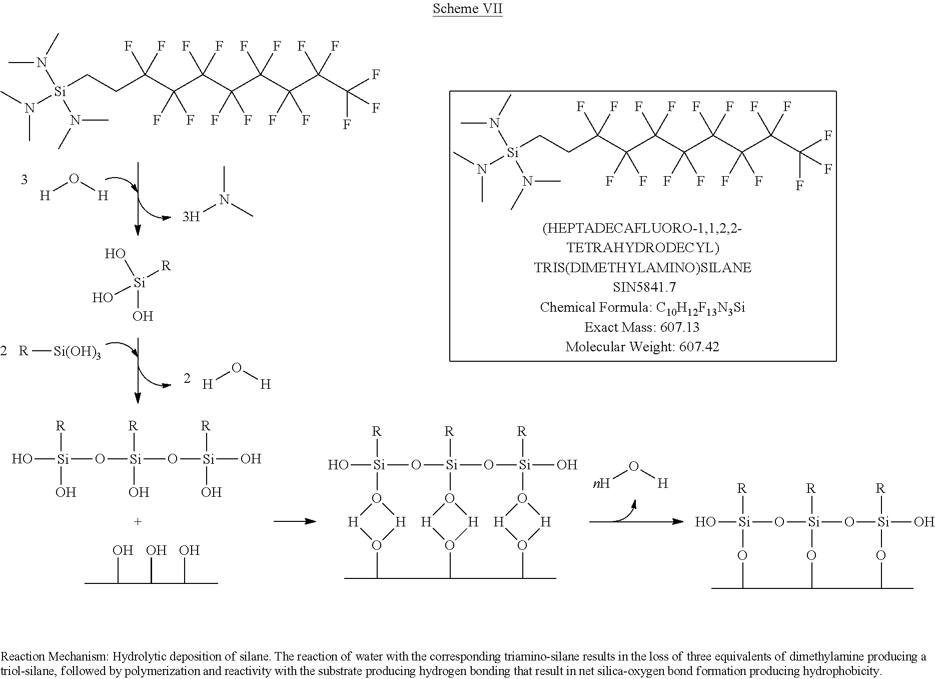

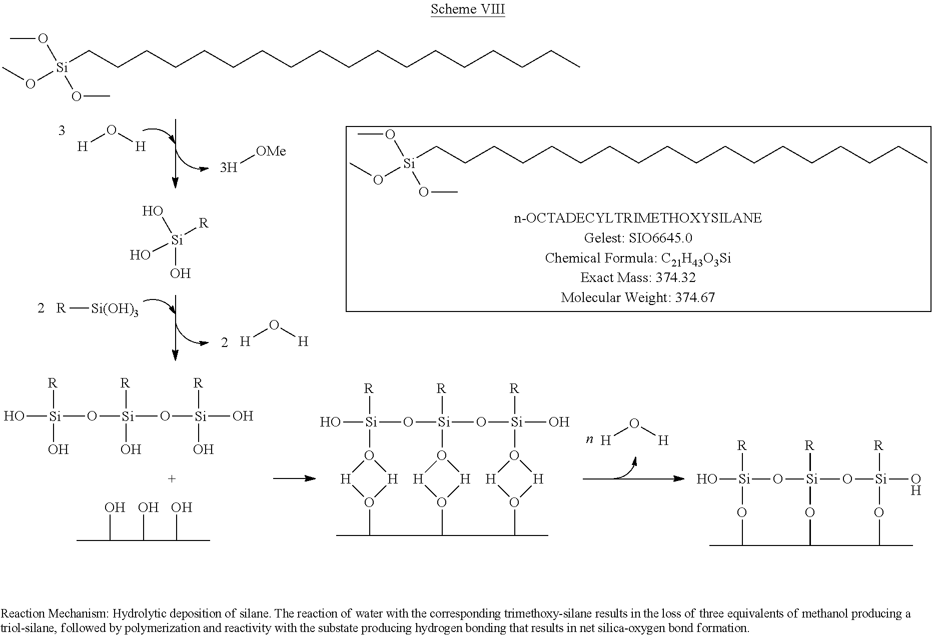

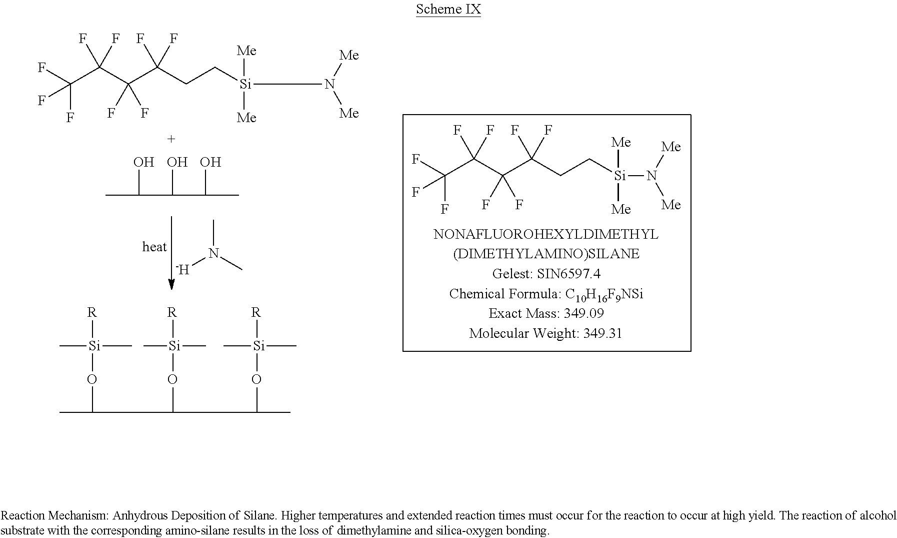

In one embodiment, the materials used to prepare non-absorbent granular litter are treated with a silanizing agent selected from dimethyldichlorosilane, hexamethyldisilazane, octyltrimethoxysilane, octyltrichlorosilane, polydimethylsiloxane, and tridecafluoro-1,1,2,2-tetrahydrooctyl trichlorosilane.

As indicated above, hydrophobic groups, and particularly silane moieties, can be covalently attached to granules of materials that form non-absorbent granular litter to make them non-wettable. The introduction of those moieties or groups is typically conducted by reaction with an agent, such as a silanizing agent, that is suspended in a suitable solvent. In some embodiments, the silanizing agent is employed at 0.25% to 5% (volume to volume where the silanizing agent is liquid, otherwise weight to volume) in a suitable solvent. In other embodiments, agents used to impart hydrophobicity and non-absorbent properties may be suspended in a range selected from: 0.5% to 4%, 0.75% to 2%, and 0.8 to 1.2%, or at about 1%; although concentrations outside of those ranges can be used. Depending on the agent used to impart hydrophobicity and non-absorbent properties, different solvents may be employed. Suitable solvents include, but are not limited to, hexane, pentane, petroleum ether, diethyl ether and other ethers, ethanol, methanol, and propanol.

Following the application of the agents to the particulate material, the solvent can be removed and recaptured for subsequent use following any needed purification (e.g., by distillation or treatment to for example to remove of water). Solvent removal can be aided by heating, which also assists in the formation of covalent linkages between the material forming the litter and the agent (e.g., silanizing agent). The time and temperature and heating profile employed will vary based upon different agents, solvents and materials being converted into a hydrophobic non-absorbent state. Heating litters to about 90° C. to 95° C. for 10 to 40 minutes or 20 to 30 minutes is generally sufficient to remove solvent and drive the reaction of silanizing agents with the litter materials.

Where compounds of formula I are used to prepare non-absorbent granular litter, the litter can comprise moieties of the formula R₃-nXnSi— where n is an integer from 0 to 2 and the open bond on the silicon atom (“Si—”) is a covalent bond to the litter granule. Alternatively, more than one bond to the litter granule may be formed where X groups are displaced to form the additional bonds.

In some embodiments the R group of R₃-nXnSi— moieties are of the form —Z—((CF₂)q(CF₃))ᵣ, where Z is a C₁₋₁₂ divalent alkane radical or a C₂₋₁₂ divalent alkene or alkyne radical, and q is an integer from 1 to 12, and r is an integer from 1-4.

In some embodiments of moieties of the formula R₃-nXnSi— n is 0, n is 1 or n is 2.

In some embodiments, all of the halogen atoms present in any one or more R groups of moieties of the formula R₃-nXnSi— are fluorine atoms.

In some embodiments, each X group of moieties of the formula R₃-nXnSi— is selected independently from H, Cl, —OR², —NHR³, and —N(R³)₂, or alternatively from Cl, —OR², —NHR³, and —N(R³)₂. In another embodiment, each X group of moieties of the formula R₃-nXnSi— is selected independently from, Cl, —NHR³, and —N(R³)2.

In one embodiment, non-absorbent granular litter comprises two or more, three or more, or four or more moieties of the formula R₃-nXnSi—.

In one embodiment, clumping or wetting animal litter (e.g., cat litter) is converted into non-absorbent granular liner using a solution of a silane (silanizing agent) in a carrier solvent such as hexane. In one embodiment, the silane useful for treating litter is tridecafluoro-1-1-2-2 tetrahydrooctyl trichlorosilane, which can be reacted with a clay litter as a 1% solution in hexane (v/v) or in other suitable solvents. In other embodiments, either clumping or non-clumping litter, which may be a clay litter, is converted is converted into non-absorbent granular litter using a solution of a silanizing agent selected from: tridecafluoro-1,1,2,2-tetrahydrooctyl)silane (SIT8173.0); (tridecafluoro-1,1,2,2-tetrahydrooctyl)trichlorosilane (SIT8174.0); (tridecafluoro-1,1,2,2-tetrahydrooctyl)triethoxysilane (SIT8175.0); (tridecafluoro-1,1,2,2-tetrahydrooctyl)trimethoxysilane (SIT8176.0); (heptadecafluoro-1,1,2,2-tetrahydrodecyl)dimethyl(dimethylamino)silane (SIH5840.5); (heptadecafluoro-1,1,2,2-tetrahydrodecyl)tris(dimethylamino)silane (SIH5841.7); n-octadecyltrimethoxysilane (SIO6645.0); n-octyltriethoxysilane (SIO6715.0); and nonafluorohexyldimethyl(dimethylamino)silane (SIN6597.4). In still another embodiment the silanizing agent is selected from dimethyldichlorosilane, hexamethyldisilazane, octyltrimethoxysilane, octyltrichlorosilane, polydimethylsiloxane, and tridecafluoro-1,1,2,2-tetrahydrooctyl trichlorosilane.

2.3 Dimensions of Animal Litter

For non-absorbent granular litter the granules can be particles having a broad range of sizes. For non-wetting litter urine forms beads and travels down to the bottom of the litter pan by gravity, and it is advantageous to have litter of an optimized size for maximum drainage of urine. A sphere or cylinder stacking model can be used to determine the relationship between the opening size (d) and the litter size (D). The relationship is given by d=(D/cos(30))−D; where d=opening or droplet diameter, and D=diameter of a sphere (or cylinder). Such a model indicates that spheres of 12.7 mm will yield a minimum clearance of 2 mm. Thus, spherical droplets of 2 mm or smaller can pass through the litter even without deforming. Note that if the litter is used as cylinders, (e.g., as may be the case where extruded through round openings) the droplet opening diameter is still the diameter of the circle inscribed within the tangent faces of three cylinders when they are stacked like logs.

Based on the relationship between droplet diameter and litter diameter, the litter size can vary from 7 mm in diameter for droplet sizes of 1 mm, and 26-mm diameter litter for a droplet size of 4 mm. In both cases, and all in between, urine is expected to easily move down by gravity to the bottom of the litter pan. Where animals are smaller than cats, such as rats and mice, it may be desirable to use smaller sized animal litter, even if some urine is retained as droplets.

In one embodiment, granules of animal litter are approximately spherical. Where litter is approximated as a sphere, the litter particles can have an average diameter that is less than a diameter selected from the group consisting of: 16, 15, 14, 13, 12, 10, 8, 6, 4, 2, and 1 mm. In such an embodiment, the litter may have an average diameter greater than about 0.5 mm.

In another embodiment, the litter has an average diameter that that is less than a diameter selected from the group consisting of: 15, 14, 13, 12, 10, 8, 6, 4, and 2 mm; in such an embodiment the litter may have an average diameter greater than about 1 mm.

In still another embodiment, the litter has an average diameter that that is less than a diameter selected from the group consisting of: 13, 12, 10, 8, 6, and 4 mm; in such an embodiment the litter may have an average diameter greater than about 3 mm.

In another embodiment, the litter has an average diameter that that is less than a diameter selected from the group consisting of: 13, 12, 10, 8, 6, and 5; in such an embodiment the litter may have an average diameter greater than about 4 mm. In another embodiment, the litter has an average diameter that that is less than a diameter selected from the group consisting of: 13, 12, 10, 8, and 6 mm; in such an embodiment the litter may have an average diameter greater than about 5 mm.

In another embodiment, the granules of animal litter are approximately cylindrical and optionally having rounded ends. Where the particles are approximated as cylinders with optionally rounded ends, the particles can have any combination of an average diameter that is less than a diameter selected from the group consisting of: 16, 15, 14, 13, 12, 10, 8, 6, 4, 2, and 1 mm, and an average length less than a length selected from the group consisting of 30, 28, 26, 24, 22, 20, 18, 16, 14, 12, 10, 9, 8, 7, 6, 5, 4, 3, 2, and 1 mm. In one embodiment, the litter has an average diameter that that is less than a diameter selected from the group consisting of: 13, 12, 10, 8, 6, and 5 mm, and an average length less than a length selected from the group consisting of 18, 16, 14, 12, 10, 9, 8, 7, and 6 mm; in such an embodiment the litter may have an average diameter greater than about 4 mm and an average length greater than about 5 mm. Non-absorbent granular litter in the form of cylinders may also be selected within the above stated ranges so that the length of the cylinder (including the rounded ends if present) is at least 2, 2.5, 3.5 or 4 times the diameter of the cylinder.

Non-absorbent granular litter may be prepared or formed into granules of the desired shape and size using any means known in the art, including, but not limited to: grinding, crushing, pelleting, extruding, or forming. Thus, methods of preparing animal litter may include a step comprising one or more of grinding crushing, pelleting, extruding or forming prior to or after the application of agents that impart hydrophobic and non-absorbent properties. In such process binders including, but not limited to polyurethanes, epoxies, plastics, clays, waxes, glues, water glass, cement, plaster, and the like, may be employed.

### 3.0 Litter Box

3.1 Features of a Litter Box

The non-absorbent granular litter described herein can be advantageously employed with litter boxes that allow for the easy removal of liquid waste. In one embodiment, the present disclosure provides an animal litter box that has surfaces with a contact angle with water that is greater than a contact angle selected from: 100, 110, 120, 130, 140, 150, 160, or 170 degrees measured at about 18 to 24° C. In particular, litter boxes may have such surfaces where the surfaces contact, or potential contact, the litter or animal wastes such as urine. In another embodiment the present disclosure provides an animal litter box that has hydrophobic surfaces, particularly hydrophobic surfaces that contact or potential contact the litter or animal wastes and non-absorbent granular litter. In such embodiments the litter may be of regular shapes and dimensions such as spheres or cylinder with optionally rounded ends described above.

In another embodiment, the present disclosure provides for an animal litter box comprising sides (100) surrounding a base (102) which is inclined toward a sump (104), a pump (200) placed in said sump positioned to remove urine received in the sump, wherein the interior surface of said litter box including said sump have a contact angle with water that is greater than a contact angle selected from: 100, 110, 120, 130, 140, 150, 160, or 170 degrees measured at about 18 to 24° C. Alternatively, all surface of the litter box exposed to litter or urine have a contact angle with water that is greater than a contact angle selected from: 100, 110, 120, 130, 140, 150, 160, or 170 degrees measured at about 18 to 24° C.

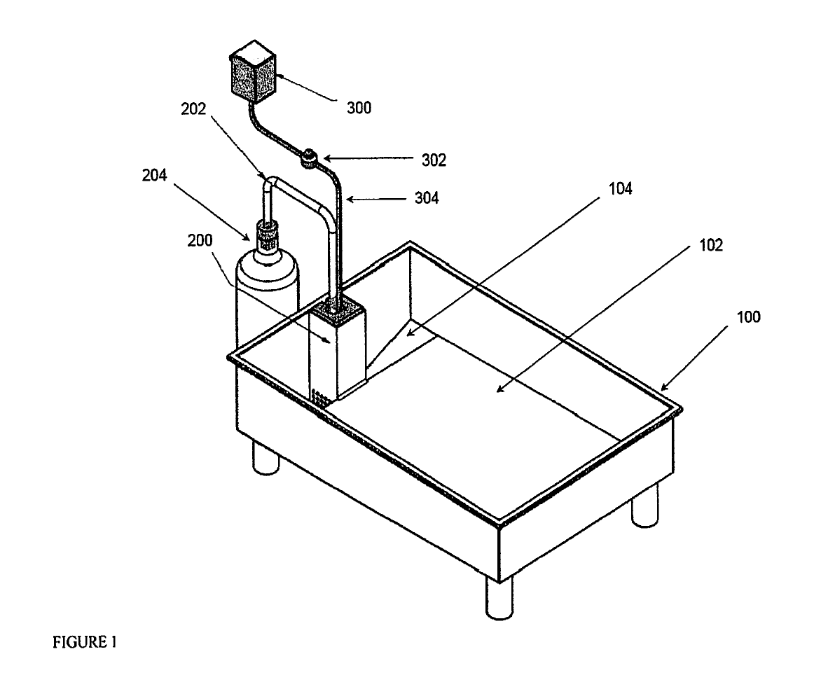

The pump (200) used in the litter box will generally have the inlet for liquids at the lowest part of the pump, such as at the bottom surface or the bottom of a side, so as to remove the maximum amount of urine or other liquids. The inlet of the pump may employ any of a variety of means to keep litter and other solid matter that is too large to be pumped from entering the pump mechanism. Thus, the inlet may be covered with mesh, or material to prevent the entry of solids. In one embodiment, the pump may comprise perforations to block solids that cannot pass through said pump from entering said pump (see the perforations at the base of the pump in FIG. 1 below the arrow indicated the pump (200)). In some embodiments, the inlet of the pump comprises perforations with a maximum opening size less than about 0.3, 0.5, 0.75 or 1 mm.

The pump is connected, by tubing or pipes, such as flexible tubing, (202) to a waste collection container/waste receptacle (204), to provide for the disposal of waste (i.e., the pump effluent). Alternatively, the waste pumped out of the litter box may be directed to sewer line via a suitable entrance such as a toilet.

The pumping mechanism may be provided with electrical power through a wire (304) connected to power supply (300). The pump may be controlled through the use of switches such as a momentary on switch (302). Alternatively, the pump may be controlled by a switch that senses urine or other liquids in the sump such as by their conductivity or the height of the liquid. The pump may also be controlled by a timer that triggers the pump to run desired intervals (e.g., hourly, or 2, 3, 4, 5, or 6 times a day). The pump may also be controlled by both a timer and a momentary on switch or a sensor that detects urine and a momentary on switch to provide for manual over ride and control of the pump as desired.

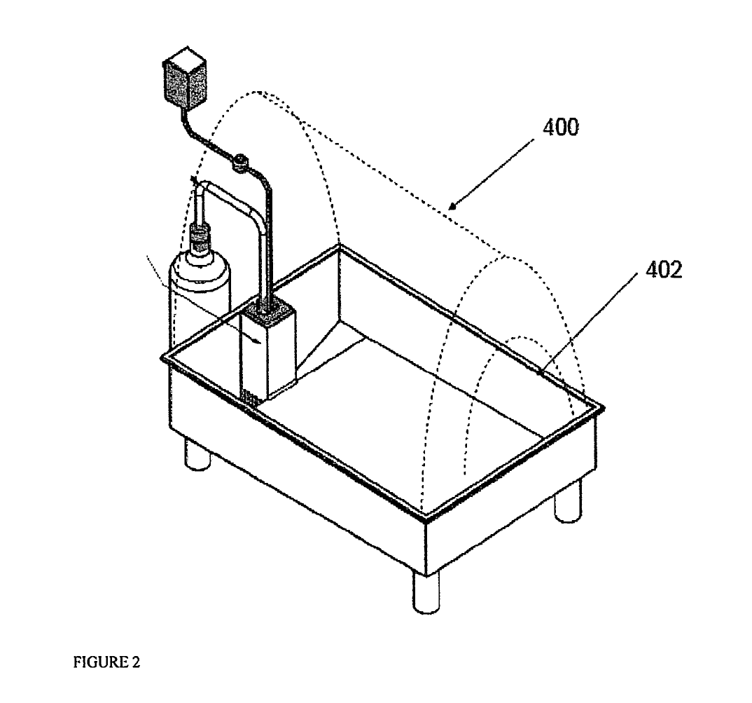

The litter box can be fitted with an enclosure (400) to keep litter from being inadvertently ejected from the litter box by animals and to contain odors. The enclosure may have virtually any shape (an arch shaped enclosure is shown in FIG. 2) that is desired provided it does not hinder the entrance or egress of animals from the litter box. In some embodiments the size of the opening may be adjusted so that an average house cat can enter the litter box without any issues. In such an embodiment, the opening has a maximum dimension less than about 30, 25, 20 or 15 cm and a minimum dimension greater than about 14 cm. In some embodiment the opening is a circle, rectangle, arch or a square. The enclosure optionally is fitted with a holder for scented or perfumed materials either on its inner or outer surface.

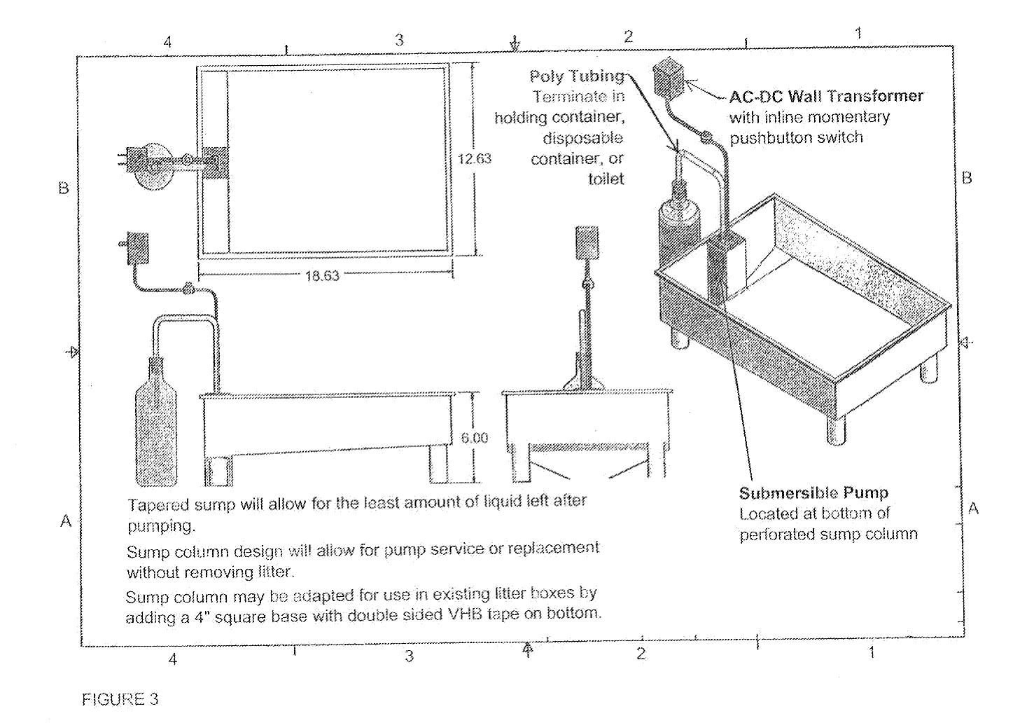

The size, dimensions, and shape of the litter box may be chosen based upon the size of the animals of cats, dogs, mice, rats, hamsters, gerbils, guinea pigs, pigs, monkeys, rabbits, or ferrets. FIG. 3 shows one embodiment of a litter box with dimensions for use with a house cat.

3.2 Water Repelling/Hydrophobic Coatings for Litter Box Surfaces.

The surface of litter boxes, and particularly the inner surfaces that may come into contact with urine, feces, and/or animal litter may be made from materials that have a contact angle with water that is greater than a contact angle selected from: 100, 110, 120, 130, 140, 150, 160, or 170 degrees measured at about 18 to 24° C.; alternatively, the surfaces are treated (e.g., coated) to provide them with a surface that has such a contact angle. In one embodiment, litter box, or the surfaces of the litter box, may comprise a material that has a suitable water contact angle or is treated so that it has such a contact angle. In one embodiment, the surfaces of a litter box may be treated with a durable hydrophobic or superhydrophobic coating, such as those described in PCT application PCT/US09/57183 entitled “Highly Durable Superhydrophobic, Oleophobic And Anti-Icing Coatings And Methods and Compositions For Their Preparation” filed Oct. 7, 2009, which is incorporated by reference in its entirety.

In one embodiment, the coating composition applied to the litter box to provide a durable hydrophobic finish (i.e., a durable hydrophobic coating) that has a surface in contact with the litter box (or an intermediate coating layer on the litter box, such as a primer), and an exposed surface that may contact animal litter, urine and/or feces, that is not is not in contact with a surface of the litter box, the coating composition comprising: i) a binder; ii) first particles having a size of about 30 microns to about 225 microns; and iii) second particles having a size of about 1 nanometer to 25 microns comprising one or more independently selected hydrophobic or oleophobic moieties; wherein said composition optionally contains 5% to 10% of a block copolymer on a weight basis.

In one embodiment, the coating composition comprises first particles in a range selected from: about 1% to about 50%; about 2% to about 40%; about 4% to about 30%; about 5% to about 25%; about 5% to about 35%; about 10% to about 25%; about 10% to about 30%; about 10% to about 40%; about 10% to about 45%; about 15% to about 25%; about 15% to about 35%; about 15% to about 45%; about 20% to about 30%; about 20% to about 35%; about 20% to about 40%; about 20% to about 45%; about 20% to about 55%; about 25% to about 40%; about 25% to about 45%; about 25% to about 55%; about 30% to about 40%; about 30% to about 45%; about 30% to about 55%; about 30% to about 60%; about 35% to about 45% or about 35% to about 50%; about 35% to about 60%, or about 40% to about 60% on a weight basis.

In one embodiment, the coating composition comprises second particles in a range selected from: about 1% to about 5%; about 2% to about 6%; about 4% to about 10%; about 6% to about 12%; about 8% to about 16%; about 1% to about 16%; about 1% to about 20%; about 10% to about 20% and about 15% to about 20% on a weight basis.

In one embodiment, the coating composition has a greater amount of second particles on, at, or adjacent to the exposed surface than the surface in contact with the substrate (e.g., the walls or base of a litter box). In another embodiment the surface in contact with said substrate has, no second particles. In another embodiment the coating composition comprises an amount of second particles on said surface in contact with said substrate, which is less than 1%, 2%, 5%, 10%, 20%, 30%, 40%, 50%, 60%, 70%, 80%, or 90% of the amount of second particles on said exposed surface, wherein said amount of second particles is determined by the number of said second particles. In such embodiments the amount of second particles and their location can determine by electron microscopy.

3.2.1 Binders

In one embodiment, the coating composition comprising the binder comprises a polyurethane, lacquer, fluoropolymer, epoxy or thermoplastic powder coating. In another embodiment the coating composition comprising binder comprises a polyurethane, lacquer, fluoropolymer, or thermoplastic powder coating. In another embodiment the coating composition comprising binder comprises a polyurethane, lacquer, or fluoropolymer. In another embodiment the coating composition comprising the binder comprises a thermoplastic powder coating. In still another embodiment the binders are hydrophilic or hydrophobic in the absence of said first particles and said second particles.

Binders used to prepare coatings applied to the surfaces of litter boxes may have a variety of compositions. Virtually any binder may be employed that is capable of adhering to the surface to be coated and retaining the desired first and second particles, both of which are described below. In some embodiments the binders employed are hydrophobic or superhydrophobic as applied in the absence of any added first or second particles.

In some embodiments the binders may be selected from lacquers, polyurethanes, fluoropolymers, epoxies, or powder coatings (thermoplastics). In other embodiments the binders may be selected from lacquers, polyurethanes, fluoropolymers, or thermoplastics. Binders may be hydrophilic, hydrophobic or superhydrophobic “as applied.” For the purposes of this disclosure, when binders or their properties are described “as applied,” it is understood that the binder(s) and properties are being described in the absence of the first and second particles described herein that alter the durability, hydrophobic/superhydrophobic and oleophobic properties of binder.

Where the binders employed are hydrophilic, the coating (with first and second particles present) will generally be given an application of a silanizing agent after it has been applied to the substrate.

In some instances, the binders are comprised of thermoplastic or thermoset polymeric materials.

In some instances, the binders are not comprised of thermoplastic or thermoset polymeric materials.

Regardless of what type of binder is employed, one consideration in choosing a suitable binder is the compatibility between the surface to be coated and any solvent(s) used to apply the binder.

The coatings formed with binders can have a broad range of thicknesses. In some embodiments the coatings will have a thickness in a range selected from about 10 microns to about 225 microns; about 15 microns to about 200 microns; about 20 microns to about 150 microns; about 30 microns to about 175 microns; or about 50 microns to about 200 microns.

3.2.1.1 Lacquer Binders

Lacquer binders typically are polymeric materials that are suspended or dissolved in carrier solvents and which dry to a hard finish, at least in part, by evaporation of the carrier solvents used to apply them. The polymeric binders present in lacquers include, but are not limited to, nitrocellulose and acrylic lacquers; each of which are suitable for use in preparing durable hydrophobic coatings.

In addition to the polymeric materials and solvents present in lacquers, a variety of other materials that enhance the properties of lacquers may be present. Such materials can provide not only color, but also increased adhesion between the lacquer and the substance upon which it is applied.

A variety of commercial lacquer preparation may be used to prepare the durable coatings described herein. Among the commercial acrylic lacquers that may be employed are “Self-Etching Primer” (Eastwood Co. Pottstown, Pa.); Dupont VariPrime 615S (Dupont Performance Coatings, Wilmington, Del.) and Nason 491-17 Etch Primer (Dupont Performance Coatings

### Wilmington, Del.)

Lacquers may be used on a variety of surfaces and are particularly useful in forming coatings on plastics, woods and metals, including, but not limited to, steel, stainless steel, and aluminum.

3.2.1.2 Polyurethane Binders

Polyurethanes are polymers consisting of a chain of organic units joined by urethane (carbamate) linkages. Polyurethane polymers are typically formed through polymerization of at least one type of monomer containing at least two isocyanate functional groups with at least one other monomer containing at least two hydroxyl (alcohol) groups. A catalyst may be employed to speed the polymerization reaction. Other components may be present in the polyurethane coating compositions including, but not limited to, surfactants and other additives that bring about the carbamate forming reaction(s) yielding a coating of the desired properties in a desired cure time.

A wide variety of polyurethanes may be used to prepare suitable coatings for the litter boxes described herein. Among the commercial polyurethanes that may be employed are the POLANE® family of polyurethanes from Sherwin Williams (Cleveland, Ohio).

Polyurethanes may come as a single component ready to apply composition or as a two or three part (component) system, as is the case with POLANE products. For example POLANE B can be prepared by mixing POLANE® B (typically six parts), to catalyst (e.g., typically one part of V66V27 or V66V29 from Sherwin Williams), and a reducer (typically 25-33% of R7K84 from Sherwin Williams).

3.2.1.3 Fluoropolymer Binders

Fluoropolymers are polymers comprising one or more fluoroalkyl groups. In some embodiments, the fluoropolymers employed in the durable coatings may be formed from Fluoroethylene/vinyl ether copolymer (FEVE).

A wide variety of fluoropolymer coatings may be used to prepare the coatings applied to litter boxes described herein. Among the commercial fluoropolymers that may be employed to the coatings are LUMIFLON® family polymers (Asahi Glass Co., Toyko, Japan). Such fluoropolymers typically come as a two or three component system, as is the case with LUMIFLON® products. For example LUMIFLON® LF can be prepared by mixing 58 parts of LUMIFLON® LF-200, 6.5 parts of DESMODUR® N3300A, (Bayer Material Sciences,) 2.5 parts of catalyst (DABCO T12 (1/10,000 part), DABCO (1,4-diazabicyclo[2.2.2]octane, 1/10,000 part), 1 part xylene), with 33 parts xylene. Unless otherwise noted, references to LUMIFLON®, particularly in the Examples, refer to LUMIFLON® LF.

Fluoropolymer coatings such as LUMIFLON® can be applied to variety of surfaces including wood, metal and concrete. Many fluoropolymers offer resistance to UV light and can therefore be used in exterior applications where the coatings are exposed to the potentially damaging effects of sunlight.

3.2.1.4 Powder Coatings

Powder coatings typically are thermoplastic or thermoset coatings that are applied on surfaces (often metal) to give a variety of desirable characteristics (e.g., colorful and slick appearance and functionalities such as corrosion protection, etc.). Powder coatings can be applied by a variety of means, including electrostatic spraying of thermoplastic or thermoset powders onto substrate surfaces. Once applied to the surface, the powder coats are subject to thermal treatment at nominal temperatures (about 400° F. or 200° C.), which melt the polymers, permitting their polymerization. The melting and solidification occur quickly, resulting in the formation of a very tenacious and durable continuous coating. Powder coat materials can be used as binders for the formation of coatings.

In some embodiments the powder coating is mixed with first particles, at the time the coating is applied to the substrate. First particles may be present in a range that is about 5% to 40%, or 10% to 30%, 10% to 35%, 15% to 30%, or 20% to 40% by weight. In one embodiment, the first particles mixed with the powder coat are Extendospheres (P.A. Industries, Inc., Chatanooga, Tenn.), which may be used at 10% to 30% by weight.

3.2.2 First Particles

A variety of first particles may be used in the coatings applied to litter boxes described herein.

In one embodiment, the first particles of the coating composition applied to litter boxes comprise a material selected from the group consisting of: wood, cellulose, glass, metal oxides, metalloid oxides, plastics, carbides, nitrides, borides, spinels, diamond and fibers. In another embodiment the first particle comprise a material selected from the group consisting of a thermoplastic or a glass. In another embodiment the first particles comprise particles that are selected from the group consisting of: wood particles, cellulose particles, glass particles, metal oxide particles, metalloid oxide particles, plastic particles, carbide particles, nitride particles, boride particles, spinel particles, diamond particles, fly ash particles, fibers and hollow glass spheres.

First particles can have an average size in a range selected from: greater than about 5 μm to about 50 μm; about 10 μm to about 100 μm; about 10 μm to about 200 μm; about 20 μm to about 200 μm; about 30 μm to about 100 μm; about 30 μm to about 200 μm; about 50 μm to about 100 μm; about 50 μm to about 200 μm; about 75 μm to about 150 μm; about 75 μm to about 200 μm; about 100 μm to about 225 μm; about 125 μm to about 225 μm; and about 100 μm to about 250 μm. In another embodiment the first particle have an average size in a range selected from: about 30 μm to about 225 μm (microns); about 30 μm to about 50 μm; about 30 μm to about 100 μm; about 30 μm to about 200 μm; about 50 μm to about 100 μm; about 50 μm to about 200 μm; about 75 μm to about 150 μm; about 75 μm to about 200 μm; about 100 μm to about 225 μm; about 100 μm to about 225 μm and about 100 μm to about 250 μm. In another embodiment the first particle have an average size greater than 30 microns and less than 250 microns.

In one embodiment, the binder is a thermoplastic powder coating. In such an embodiment the first particles can be extended spheres. Where the binder is a thermoplastic powder coating the powder coat can be mixed with an amount of first particles in a range selected from: from 5% to 60%; from 10% to 30%; from 20% to 30%; from 22% to 27%; from 20% to 40%; from 20% to 50%; from 30% to 40%; and from 30% to 50% on a weight basis. Second particles may be applied over the powder coating before or after heating the coating to cure it. In such an embodiment first particles may or may not be treated with a silanizing agent.

In one embodiment, first particles do not comprise one or more independently selected hydrophobic and/or oleophobic moieties covalently bound to said first particle.

3.2.3 Second Particles

Second particles having a wide variety of compositions may be employed in the coatings applied to litter boxes described herein. In some embodiments the second particles will be particles of metal oxides (e.g., aluminum oxides, zinc oxides, nickel oxide, zirconium oxides, iron oxides, or titanium dioxide) such as alumina, or oxides of metalloids (e.g., oxides of B, Si, Sb, Te and Ge) such as silicates (e.g., fumed silica) or particles comprising one or more metal oxides, oxides of metalloids or combination thereof, such as second particles of glasses. The particles are treated to introduce one or more moiety (group) that imparts water repelling or hydrophobic properties to the particles either prior to incorporation into the compositions that will be used to apply coatings or after they are incorporated into the coatings. In one embodiment, second particles are treated with silanizing agents to incorporate groups that will give the particles water repelling or hydrophobic properties.

In some embodiments, suitable second particles have a size from about 1 nanometers (nm) to 25 microns and are capable of binding covalently to one or more chemical groups (moieties) that provide the second particles, and the coatings into which they are incorporated, one or more of hydrophobic and/or oleophobic.

In some embodiments the second particles may have an average size in a range selected from about 1 nm to about 100 nm; about 10 nm to about 200 nm; about 20 nm to about 400 nm; about 10 nm to 500 nm; about 40 nm to about 800 nm; about 100 nm to about 1 micron; about 200 nm to about 1.5 microns; about 500 nm to about 2 microns; about 500 nm to about 2.5 microns; about 1.0 micron to about 10 microns; about 2.0 microns to about 20 microns; about 2.5 microns to about 25 microns; about 500 nm to about 25 microns; about 400 nm to about 20 microns; or about 100 nm to about 15 microns.

In one embodiments, such as where the second particles are prepared by fuming (e.g., fumed silica or fumed zinc oxide), the second particles may have an average size in a range selected from about 1 nm to about 50 nm; about 1 nm to about 100 nm; about 1 nm to about 400 nm; about 1 nm to about 500 nm; about 2 nm to about 120 nm; about 5 nm to about 150 nm; about 5 nm to about 400 nm; about 10 nm to about 300 nm; or about 20 nm to 400 nm.

In one embodiment second particles are silica (silicates), alumina (e.g., Al₂O₃), a titanium oxide, or zinc oxide, that are optionally treated with a silanizing agent.

In another embodiment, the second particles are comprised of fumed silica; and in a further embodiment, the second particles are comprised of fumed silica and have an average size in the range of 1 nm to 100 nm or 2 nm to 200 nm; wherein the silica is optionally treated with a silanizing agent.

In yet another embodiment second particles are comprised of one or more metals, metal oxides (e.g., zinc oxide, titanium dioxide, Al₂O₃), metalloids (e.g., B, Si, Sb, Te and Ge), oxides of a metalloid (e.g., SiO₂ and silicates), or glasses. In such an embodiment the one or more independently selected second particles have average sizes in ranges independently (separately) selected from about 1 nm to about 100 nm; about 10 nm to about 200 nm; about 20 nm to about 400 nm; about 10 nm to 500 nm; about 40 nm to about 800 nm; about 100 nm to about 1 micron; about 200 nm to about 1.5 microns; about 500 nm to about 2 microns; about 500 nm to about 2.5 microns; about 1.0 micron to about 10 microns; about 2.0 microns to about 20 microns; about 2.5 microns to about 25 microns; about 500 nm to about 25 microns; about 400 nm to about 20 microns; or about 100 nm to about 15 microns. Second particles in such an embodiment may be employed in coatings prepared using thermal spray processes.

In any of the above-mentioned embodiments, the lower size of second particles may be limited to particles greater than 20 nm, 25 nm, 30 nm, 35 nm, 40 nm, 45 nm, 50 nm, or 60 nm. Similarly, in any of the above-mentioned embodiments, the upper size of second particles may be limited to particles less than 20, 10, 5, 1, 0.8, 0.6, 0.5, 0.4, 0.3 or 0.2 microns. Limitation on the upper and lower size of second particles may be used alone or in combination with any of the above-recited size limits on particle composition, percent composition in the coatings, etc.

Second particles employed in the preparation of the durable coatings described herein comprise one or more independently selected chemical groups (moieties or functionalies) that impart water repellant and/or hydrophobic properties to provide the second particles, and the coatings into which they are incorporated. Second particles typically will be treated with agents that introduce such moieties before being incorporated into the coatings applied to the litter boxes described herein, however, it is also possible to treat the coating after it is applied to a surface with agents that modify the second particles and introduce or more of hydrophobic, and/or oleophobic properties. In such circumstances, other components of the coating (e.g., the binder or first particles) may also become modified by the agent.

In some embodiments, the second particles will be treated with an agent that introduces one or more hydrophobic, superhydrophobic or oleophobic properties.

In another embodiment the second particles will bear one or more alkyl, haloalkyl, fluoroalkyl, and perfluoroalkyl moieties. Such moieties can be covalently bound directly or indirectly bound to the second particle, such as through one or more intervening silicon or oxygen atoms.

In still another embodiment the second particles will bear one or more alkyl, fluoroalkyl, and perfluoroalkyl moieties of the formula R₄₋ₙSi—, where n is from 1-3, that are directly or indirectly bound (e.g., covalently bound) to the second particle, such as through one or more intervening atoms.

3.2.4 First and Second Particle Combinations and Treatment of Particles and Coatings to Provide Water Repellant/Hydrophobic Properties.

In one embodiment, the coating composition does not contain only particles with a size of 25 microns or less, or only particles with an average size of 25 microns or less. In another embodiment the composition does not contain only particles with a size of 30 microns or less, or only particles with an average size of 30 microns or less. In another embodiment the composition does not contain only particles with a size of 50 microns or less, or only particles with an average size of 50 microns or less.

In one embodiment, the first or second particles independently comprises one or more independently selected hydrophobic and/or oleophobic moieties covalently bound to said first or second particle. In another embodiment, the one or more hydrophobic and/or oleophobic moieties comprise one or more independently selected alkyl, fluoroalkyl or perfluoroalkyl moieties. In such embodiments first particles may not be treated with a silanizing agent and second particles are treated.

In some embodiment the first and/or or second particles comprise one or more covalently bound hydrophobic or oleophobic moieties selected independently that have the form:

R₃₋ₙXₙSi—

where n is an integer from 0 to 2;

each R is independently selected from
(i) alkyl or cycloalkyl group optionally substituted one or more fluorine atoms,
(ii) C₁₋₂₀ alkyl optionally substituted with one or more independently selected substituents selected from fluorine atoms and C₆₋₁₄ aryl groups, which aryl groups are optionally substituted with one or more independently selected halo, C₁₋₁₀ alkyl, Cl₁₋₁₀ haloalkyl, C₁₋₁₀ alkoxy, or C₁₋₁₀ haloalkoxy substituents,
(iii) C_{6 to 20} alkyl ether optionally substituted with one or more substituents independently selected from fluorine and C₆₋₁₄ aryl groups, which aryl groups are optionally substituted with one or more independently selected halo, C₁₋₁₀ alkyl, C₁₋₁₀ haloalkyl, C₁₋₁₀ alkoxy, or C₁₋₁₀ to haloalkoxy substituents,
(iv) C₆₋₁₄ aryl, optionally substituted with one or more substituents independently selected from halo or alkoxy, and haloalkoxy substituents;
(v) C_{4 to 20} alkenyl or C_{4 to 20} alkynyl, optionally substituted with one or more substituents independently selected from halo, alkoxy, or haloalkoxy; and
(vi) —Z—((CF₂)_{q}(CF₃))ᵣ, wherein Z is a C₁₋₁₂ divalent alkane radical or a C₂₋₁₂ divalent alkene or alkyne radical, q is an integer from 1 to 12, and r is an integer from 1-4);

each X is independently selected from —H, —Cl, —I, —Br, —OH, —OR², —NHR³, or —N(R³)₂;

each R² is independently selected C₁₋₄ alkyl or haloaklyl group; and

each R³ is independently an independently selected H, C₁₋₄ alkyl or haloalkyl group. In such an embodiment first particles may not be treated with a silanizing agent.

Where first or second particles comprise moieties of the formula R₃₋ₙXₙSi—, it is understood that more than one bond “—” to the particle may be made by displacing one or more X groups to form the bond with the surface.

In one embodiment, only second particles are treated with silanizing agents, and first particles are not treated with silanizing agents.

In one embodiment, the second particles are prepared by treating a particle having a size of about 1 nanometer to 25 microns with a silanizing agent selected from: tridecafluoro-1,1,2,2-tetrahydrooctyl)silane (SIT8173.0); (tridecafluoro-1,1,2,2-tetrahydrooctyl)trichlorosilane (SIT8174.0); (tridecafluoro-1,1,2,2-tetrahydrooctyl)triethoxysilane (SIT8175.0); (tridecafluoro-1,1,2,2-tetrahydrooctyl)trimethoxysilane (SIT8176.0); (heptadecafluoro-1,1,2,2-tetrahydrodecyl)dimethyl(dimethylamino)silane (SIH5840.5); (heptadecafluoro-1,1,2,2-tetrahydrodecyl)tris(dimethylamino)silane (SIH5841.7); n-octadecyltrimethoxysilane (SIO6645.0); n-octyltriethoxysilane (SIO6715.0); and nonafluorohexyldimethyl(dimethylamino)silane (SIN6597.4). In such an embodiment first particles may not be treated with a silanizing agent.

In another embodiment the second particles are prepared by treating a particle having a size of about 1 nanometer to 25 microns with a silanizing agent selected from: dimethyldichlorosilane, hexamethyldisilazane, octyltrimethoxysilane, polydimethylsiloxane, and tridecafluoro-1,1,2,2-tetrahydrooctyl trichlorosilane. In such an embodiment first particles may not be treated with a silanizing agent.

In another embodiment the said second particles are silica particles prepared by treating said silica particles with an agent that will increase the number of sites on the silica particles that can react with a silanizing agent prior to being treated with said silanizing agent. In such an embodiment, the silanizing agent can be selected from any silanizing agent recited herein.

### EXAMPLES

### Example 1

A commercial clumping clay is made into non-absorbent granular litter by application of a 1% (tridecafluoro-1,1,2,2-tetrahydrooctyl)trichlorosilane (Gelest product SIT8174.0) (silanizing agent), in hexane, after which the litter was dried by allowing the hexane to evaporate, followed by heating to about 90-95° C. for about 20 to about 30 minutes. An aluminum pan with a slit cut in the bottom to collect liquid not retained by the litter is used to test the response of clumping clay versus treated silane treated clay. For each test, a 2-in.-thick layer of treated and untreated litter was loaded into the aluminum pan with the slit. In each case, 200 ml of liquid (water) was poured over the clay.

For untreated litter, no water is collected through the slit. For treated litter, 186 ml of water is collected. Some of the 14 ml of water adventitiously adheres to the aluminum pan, the funnel used to collect water, and to the graduated cylinder used to measure the water. A few water drops are also seen trapped between the litter particles.

When clumping clay litters with large particle sizes are used the amount of water trapped between particles is minimized, and almost all of the water comes through the litter (data not shown).

### Example 2

A second sample of clumping cat litter TIDY CATS® by PURINA® is treated as in example 1. The response of treated and untreated litter to water absorption is tested in the manner similar to that described in Example 1 above. For untreated litter, 183 ml of the 200 ml water used was absorbed. This is absorption of 92%. The treated litter 15 ml of water was retained by the litter as trapped water droplets or as absorbed water, with approximately 93% of the water passing through the litter.

### Example 3

A cat litter formed into cylindrical pellets sold under the name BREEZE® by PURINA® is tested for water absorbance after treatment with 1% (tridecafluoro-1,1,2,2-tetrahydrooctyl)trichlorosilane (Gelest product SIT8174.0) in hexane and drying as in Example 1. This litter is advertised to be non-wetting and free from dust that is common with the clumping clay. After treatment, control untreated litter pellets and treated litter pellets are tested for their wetting response as described above. Control samples that are untreated with silanizing agent are wetted, whereas the treated pellets repel water and do not absorb significant amounts of water, if water is absorbed at all.

### Example 4

BREEZE® cat litter by PURINA® is treated with (tridecafluoro-1,1,2,2-tetrahydrooctyl)trichlorosilane (Gelest product SIT8174.0) in two different solvents, hexane and ethanol. The silane solution in hexane is prepared and employed as a 1% v/v solution. The silane solution in ethanol is prepared and employed as a 2% v/v solution. Pellet samples are treated with silane in both solvents, air dried to allow the solvent to evaporate, followed by heating to about 90-95° C. for about 20 to about 30 minutes. Both samples are found to make the pellets into non-absorbent granular litter. The results show that while hexane results in excellent non-water absorbing performance, ethanol will result in some water absorption after a period of time. Even then, the non-water absorbing behavior of pellets treated in ethanol is superior to untreated pellets.

### Example 5

Clumping clay litter that is untreated or treated with (tridecafluoro-1,1,2,2-tetrahydrooctyl)trichlorosilane (Gelest product SIT8174.0) as described in Example 1 is tested for its wetting response to human urine, in the presence and absence of an odor remover. In addition, we also evaluated the response of adding an odor remover solution to both untreated and treated litter exposed to human urine. Litter that is not treated with the silanizing agent wets, absorbs water and clumps. In contrast, litter treated with the silane does not absorb water whether treated with an odor control agent 10% solution of “ ” in water or not. The odor treatment also eliminates the smell of the urine. Odor treatment can also be applied non-wetting litter that has been previously exposed to urine to remove the odor and residual urine waste from the litter.

### Example 6

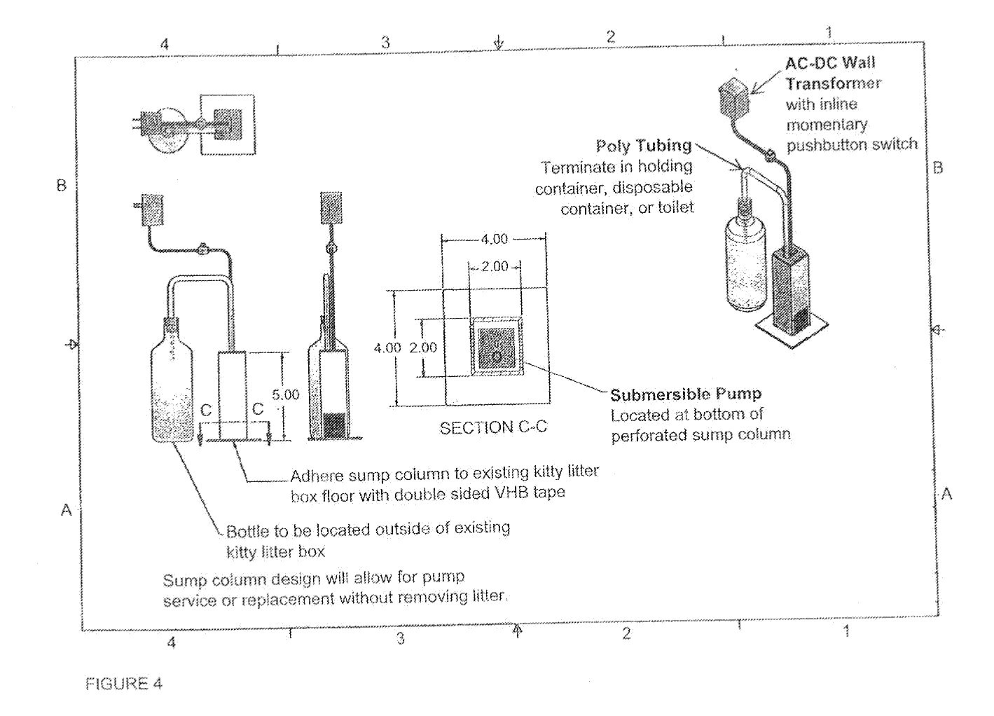

As shown in the Examples 1-4, treatment of animal litter, particularly clay based litter, can make the litter non-water absorbent. This means that if treated litter is used, the litter will stay dry and urine will stay as separated liquid in the litter tray/box. Urine passing through the litter can be collected and removed from the litter employing a litter box with a urine pumping system and an optional collection system is shown in FIG. 3. In the design shown the tray bottom is sloped so that all of the urine will collect in the sump area. The sump area is also tapered to minimize any remaining liquid in the sump area. The sump column design will allow the urine removal without having to change the litter. The design in FIG. 4 is generic, and the dimensions given are proposed.

### Example 7

A sump column (pump) in Example 6 can also be used with an existing litter box. In one embodiment, the sump column is fitted with an adhesive base for application to an existing litter box. See FIG. 4.

### Example 8

### Applying a Water Repellant and/or Hydrophoboic Coating to Litter Box Surfaces

Litter boxes are cleaned with acetone and are coated in a two step process comprising applying a base coat followed by application of a top-coat (second coat). Each litter box is spray-coated with a base coat comprising a Self-Etching Primer as a binder (Eastwood Co., Pottstown, Pa.) containing first particles of: 512 black, (Xiom Corp., West Babylon, N.Y.); Nulok 390 (Kamin LLC, Macon, Ga.); or 200 White, (Xiom Corp, West Babylon, N.Y.). After drying in air, this base coat is top-coated with second particles of TS-720 (Evonik Industries, Essen, Germany) pre-treated with polydimethylsiloxane or silica second particles treated with a 1% solution of (tridecafluoro-1,1,2,2-tetrahydrooctyl)trichlorosilane (product SIT8174 from Gelest, Pottstown, Pa.). For application as the top-coat, the second particles are suspended in ethanol or hexane at about 4 g/100 ml.

1. An animal litter composition comprising a non-absorbent granular material having a contact angle with water greater than about 90 degrees.

2. The litter composition of claim 1, wherein said granular material comprises one or more of: plant materials, clay(s), silica, glass, ceramic, fly ash, slag, gypsum, water glass based materials, chalk based materials, coarse DE particulates, cardboard, cardboard coated with water glass, gravel, vermiculite, perlite, investment slurry coated paper, and card board, extruded rubber, ground rubber, or plastic.

3-4. (canceled)

5. The composition of claim 2, wherein said granular material is comprised of one or more clays.

6. The composition of claim 5, wherein said one or more clays comprise bentonite, kaolin or a combination thereof.

7-9. (canceled)

10. The composition according to claim 2, wherein said granular material comprises a plastic selected from the group consisting of: polyolefins, polyvinylchloride, a polyamides, a polyimides, a polyamideimides, a polyesters, aromatic polyesters, polycarbonates, polystyrenes, polysulfides, polysulfones, polyethersulfones, polyphenylenesulfides, a phenolic resins, polyurethanes, epoxy resins, a silicon resins, acrylonitrile butadiene styrene resin/plastic, methacrylic resins/plastics, acrylate resins, polyacetals, polyphenylene oxides, polymethylpentenes, melamines, alkyd resins, polyesters or unsaturated polyesters, polybutylene terephthlates or nylon.

11. (canceled)

12. Composition according to claim 1, wherein said non-absorbent granular material is produced by treatment of said granular material with one or more, two or more, three or more, or four or more silanizing agents.

13. The composition of claim 12, wherein said material is treated with a silanizing agent of formula (I):
R₄₋ₙSi—Xₙ (I)
where n is an integer from 1 to 3;
each R is independently selected from
(i) alkyl or cycloalkyl group optionally substituted one or more fluorine atoms,
(ii) C₁₋₂₀ alkyl optionally substituted with one or more independently selected substituents selected from fluorine atoms and C₆₋₁₄ aryl groups, which aryl groups are optionally substituted with one or more independently selected halo, C₁₋₁₀ alkyl, C₁₋₁₀ haloalkyl, C₁₋₁₀ alkoxy, or C₁₋₁₀ haloalkoxy substituents,
(iii) C_{6 to 20} alkyl ether optionally substituted with one or more substituents independently selected from fluorine and C₆₋₁₄ aryl groups, which aryl groups are optionally substituted with one or more independently selected halo, C₁₋₁₀ alkyl, C₁₋₁₀ haloalkyl, C₁₋₁₀ alkoxy, or C₁₋₁₀ haloalkoxy substituents,
(iv) C₆₋₁₄ aryl, optionally substituted with one or more substituents independently selected from halo or alkoxy, and haloalkoxy substituents;
(v) C_{6 to 20} alkenyl or C_{6 to 20} alkynyl, optionally substituted with one or more substituents independently selected from halo, alkoxy, or haloalkoxy; and
(vi) —Z—((CF₂)_{q}(CF₃))ᵣ, wherein Z is a C₁₋₁₂ divalent alkane radical or a C₂₋₁₂ divalent alkene or alkyne radical, q is an integer from 1 to 12, and r is an integer from 1-4;
each X is independently selected from —H, —Cl, —I, —Br, —OH, —OR², —NHR³, or —N(R³)₂;
each R² is independently selected C₁₋₄ alkyl or haloaklyl group; and
each R³ is independently an independently selected H, C₁₋₄ alkyl or haloalkyl group.

14-25. (canceled)

26. The composition of claim 1, wherein said granular material has an average diameter that is less than a diameter selected from the group consisting of: 16, 15, 14, 13, 12, 10, 8, 6, 4, 2, 1, 0.5 mm.

27-33. (canceled)

34. A method of preparing animal litter comprising non-absorbent granular material having a contact angle with water greater than 90 degrees comprising treating said granular material with one or more, two or more, three or more, or four or more silanizing agents.

35. The method of claim 34, wherein said granular materials is treated with a silanizing agent of formula (I):
R₄₋ₙSi—Xₙ (I)
where n is an integer from 1 to 3;
each R is independently selected from
(i) alkyl or cycloalkyl group optionally substituted one or more fluorine atoms,
(ii) C₁₋₂₀ alkyl optionally substituted with one or more independently selected substituents selected from fluorine atoms and C₆₋₁₄ aryl groups, which aryl groups are optionally substituted with one or more independently selected halo, C₁₋₁₀ alkyl, C₁₋₁₀ haloalkyl, C₁₋₁₀ alkoxy, or C₁₋₁₀ haloalkoxy substituents,
(iii) C_{6 to 20} alkyl ether optionally substituted with one or more substituents independently selected from fluorine and C₆₋₁₄ aryl groups, which aryl groups are optionally substituted with one or more independently selected halo, C₁₋₁₀ alkyl, C₁₋₁₀ haloalkyl, C₁₋₁₀ alkoxy, or C₁₋₁₀ haloalkoxy substituents,
(iv) C₆₋₁₄ aryl, optionally substituted with one or more substituents independently selected from halo or alkoxy, and haloalkoxy substituents;
(v) C_{6 to 20} alkenyl or C_{6 to 20} alkynyl, optionally substituted with one or more substituents independently selected from halo, alkoxy, or haloalkoxy; and
(vi) —Z—((CF₂)_{q}(CF₃))ᵣ, wherein Z is a C₁₋₁₂ divalent alkane radical or a C₂₋₁₂ divalent alkene or alkyne radical, q is an integer from 1 to 12, and r is an integer from 1-4;
each X is independently selected from —H, —Cl, —I, —Br, —OH, —OR², —NHR³, or —N(R³)₂;
each R² is independently selected C₁₋₄ alkyl or haloaklyl group; and
each R³ is independently an independently selected H, C₁₋₄ alkyl or haloalkyl group.

36-45. (canceled)

46. The method of claim 34, wherein said granular material is treated with a silanizing agent selected from tridecafluoro-1,1,2,2-tetrahydrooctyl)silane (SIT8173.0); (tridecafluoro-1,1,2,2-tetrahydrooctyl)trichlorosilane (SIT8174.0); (tridecafluoro-1,1,2,2-tetrahydrooctyl)triethoxysilane (SIT8175.0); (tridecafluoro-1,1,2,2-tetrahydrooctyl)trimethoxysilane (SIT8176.0); (heptadecafluoro-1,1,2,2-tetrahydrodecyl)dimethyl(dimethylamino)silane (SIH5840.5); (heptadecafluoro-1,1,2,2-tetrahydrodecyl)tris(dimethylamino)silane (SIH5841.7); n-octadecyltrimethoxysilane (SIO6645.0); n-octyltriethoxysilane (SIO6715.0); and nonafluorohexyldimethyl(dimethylamino)silane (SIN6597.4).

47-64. (canceled)

65. An animal litter comprising non-absorbent granular material prepared by the method of claim 34.

66. An animal litter box comprising sides surrounding a base which is inclined toward a sump, a pump placed in said sump positioned to remove urine received in said sump, wherein the interior surfaces of the litter box, including said sump, are hydrophobic or superhydrophobic.

67. The litter box according to claim 66, wherein all surface of the litter box exposed to litter are hydrophobic or superhydrophobic, or all surfaces of said litter box are hydrophobic or superhydrophobic.

68-69. (canceled)

70. The litter box according to claim 66, wherein said pump is controlled by a momentary on switch or a switch that detects the presence of urine in said sump.

71-82. (canceled)

83. The litter box according to claim 66, further comprising litter according to claim 1.
